(19) United States
(12) Patent Application Publication
(10) Pub. No.: US 2006/0213857 A1
(43) Pub. Date: Sep. 28, 2006

(54) Bottle that reduces the risk of tooth decay

(76) Inventors: Charlene Chen, San Francisco, CA (US); N. William Quach, San Francisco, CA (US)

Correspondence Address: PARSONS HSUE & DE RUNTZ LLP, 595 MARKET STREET, SUITE 1900, SAN FRANCISCO, CA, 94105, US

(21) Appl. No.: 11/092,206

(22) Filed: Mar. 28, 2005

(51) Int. Cl. B65D 1/04; A61J 11/00; A61J 9/00; B65D 23/12

(52) U.S. Cl. 215/11.1; 215/6; 215/11.4; 215/386

(57) ABSTRACT

To reduce tooth decay in children such as infants, the feeding bottle contains two reservoirs where one reservoir substantially surrounds the other. Such construction permits the reservoirs to be more easily filled without spillage and allows the reservoirs to be more readily cleaned. Such construction also gives the illusion that only a preferred liquid is contained in the feeding bottle, thereby rendering it easier for parents to persuade a child to drink from the bottle.

### BACKGROUND OF THE INVENTION

The invention relates generally to bottles and more particularly to bottles capable of reducing the risk of tooth decay for children.

The baby bottle has provided a source of nutrients in the early developmental stages of children for many generations. Parents feed youngsters not only formula but, in addition, other liquids with nutritional value, such as milk, fruit juice, sugar water, sweetened gelatin, soft drinks, and other sweetened liquids.

Unfortunately, the usage of baby bottles has resulted in a condition known as baby bottle tooth decay which has been increasingly prevalent in children. Such condition of advanced tooth decay has been attributed to frequent exposure of children's teeth for extended periods of time to liquids containing sugars. The sugars in the liquid are a source of food for bacteria. The byproduct acids cause tooth decay.

The frequency and length of duration of exposure of a child's teeth to sugars is a risk factor which affects tooth decay. Parents have been advised against permitting children to fall asleep sucking on a bottle. On such occasions, once the child fell asleep, the natural flow of saliva decreased and the sugar containing liquids were allowed to pool around the teeth for long periods, which has been known to result in excessive decay.

However, parents have often found few alternatives to baby bottles for satisfying a cranky child's sucking desires in order to put the child to sleep. In these instances, children have often rejected plain water, preferring sweet liquids.

Wagner, in U.S. Pat. No. 4,856,995, proposes a multiple reservoir nursing bottle. The nursing bottle proposed by Wagner includes a pair of reservoirs which can be selectively coupled to a single nipple. One of the reservoirs is filled with a sugar containing liquid and the other reservoir with a sugar free liquid. The nipple is interconnected to the sugar containing liquid for pacifying the child. Thereafter, the nipple is connected instead to the sugar free liquid prior to cessation of sucking to rinse the sugars from the child's oral cavity in order to reduce tooth decay.

In one embodiment of the nursing bottle proposed by Wagner, the two reservoirs are formed by two flexible bag type liquid reservoirs that are placed side by side. The nursing bottle includes a hollow body for housing the two reservoirs and an intermediate ring having a first valve plate with two apertures, each one of the two apertures being connected to one of the two reservoirs for supplying liquid from such reservoir through the corresponding aperture to the nipple. A second valve plate having a single aperture is placed in contact with the first valve plate and between the first valve plate and the nipple so that the two valve plates may be rotated relative to each other. When the two valve plates are in one relative position to each other, the single aperture in the second valve plate will be in fluid communication with one of the two apertures in the first valve plate. By rotating the two valve plates relative to each other by 180°, the single aperture in the second valve plate will be in fluid communication with the other aperture in the first valve plate. The single aperture in the second valve plate is in communication with the nipple. Thus by the relative rotation of the two valve plates, fluid communication can be selectively established between each one of the two reservoirs and the nipple. As an alternative embodiment, Wagner describes in FIGS. 6 and 7, separate liquid reservoirs are formed in the body of the bottle and the intermediate ring of valve disc is not employed.

The nursing bottle proposed by Wagner is disadvantageous for a number of reasons. The reservoirs, either in the form of flexible bags or rigid compartments inside the nursing bottle, are open to the outside through small openings. This means that it may be difficult to pour liquid into the compartments or flexible bags without spilling. It also means that these reservoirs will be difficult to clean. Since many parents are very sensitive to cleanliness when using nursing bottles, such design may inherently discourage the use of the nursing bottle proposed by Wagner. Furthermore, parents feeding a cranky baby may often be holding the baby in one hand and using the bottle to feed the baby with the other hand. The design contemplated by Wagner apparently requires the parent to rotate the valve plate by 180°, which may be difficult to accomplish using a single hand. Thus the nursing bottle proposed by Wagner may be rather inconvenient in such circumstances for parents.

It is therefore desirable to provide an improved bottle in which the above-described difficulties are not present.

### SUMMARY OF THE INVENTION

This invention is based on the recognition that by designing a bottle where one reservoir substantially surrounds another, many of the above-described difficulties can be alleviated. Where one reservoir substantially surrounds another, such configuration makes it possible to employ larger or wider openings to the reservoirs, thereby rendering them easier to be filled with the appropriate liquids and/or cleaned. Since one reservoir substantially surrounds another, it is easier for parents to camouflage the fact that the bottle contains sugar free liquids as well as sugar containing liquids. This would render it easier for parents to persuade children to drink from the bottle.

In one embodiment, one reservoir is placed inside another and is removably connected to the other reservoir. In this manner, liquid may be first poured into the larger reservoir before the smaller reservoir is placed therein, rendering it easier to fill the larger reservoir. After use, the smaller reservoir may also be removed from the larger reservoir, thereby enabling both reservoirs to be more easily cleaned.

The above-mentioned design also enables the valve mechanism to be designed so that one valve member need not be rotated relative to another valve member by a large angle. This renders it easier for parents to operate the valving mechanism by one hand only, thereby freeing the other hand for holding the baby when necessary. Thus there is no need for the parent to first put the baby down, adjust the valve to change the selection of feeding liquid, and pick the baby up again to resume feeding.

The above-described features may be used independently of one another, or in any combination thereof, to provide a versatile bottle that will help reduce tooth decay in children.

### BRIEF DESCRIPTION OF THE DRAWINGS

FIG. 1 is a view of a bottle to illustrate one embodiment of the invention.

FIG. 2 is an exploded view of the bottle of FIG. 1.

FIG. 3A is a posterior schematic perspective view of the bottle of FIG. 1.

FIG. 3B is a schematic view of a zipping cap which may be used to replace the nipple in FIG. 3A to illustrate another aspect of the invention.

FIGS. 4A and 4C are side views of two valve members which may be used together in the embodiment of FIG. 1.

FIGS. 4B and 4D are each a cross-sectional view of an edge of a portion of the valve members in respective circles in FIGS. 4A and 4C respectively.

FIGS. 5A-5C are cross-sectional views of portions of the two valve members in three different relative positions to illustrate the operation of a valving mechanism using the two valve members.

For convenience and description, identical components are labeled by the same numerals in this application.

### DETAILED DESCRIPTION OF EXEMPLARY EMBODIMENTS

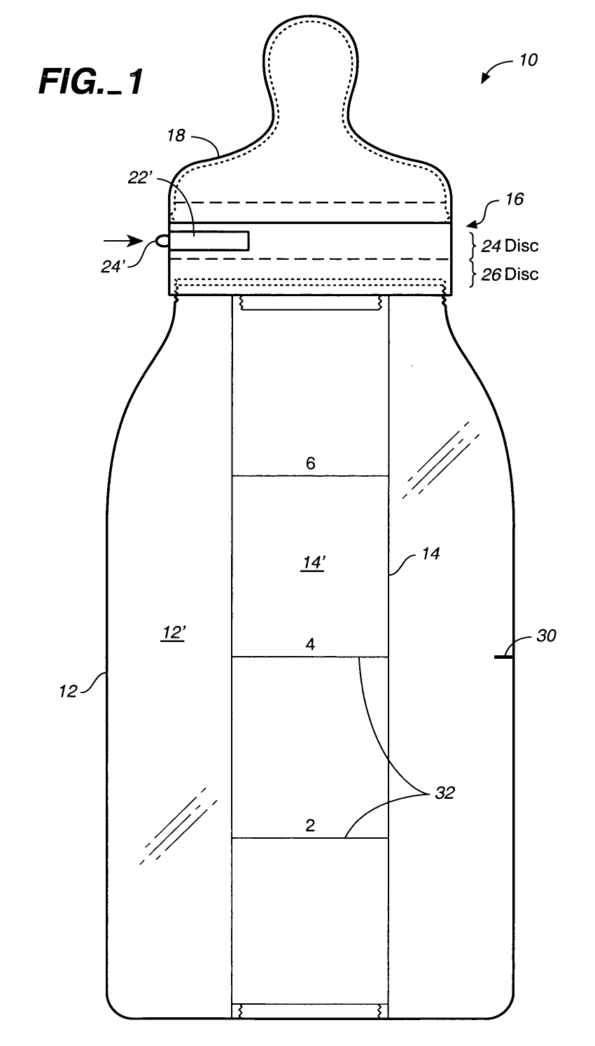

FIG. 1 is a schematic view of a bottle illustrating one embodiment of the invention. As shown in FIG. 1, feeding device 10 includes a bottle 12 which defines a chamber 12′ therein serving as a reservoir 12′ for a liquid, such as water. In the embodiment of FIG. 1, the chamber 12′ of bottle 12 holds therein a container 14 which defines therein another reservoir 14′ for holding another liquid which can be different from the liquid in chamber or reservoir 12′. Preferably, container 14 is removably connected to the inside surface of chamber 12′, such as by a snap-fit mechanism. Alternatively, the bottom portion of container 14 may define grooves therein which are complementary to the grooves in a protruding portion (not shown in FIG. 1) from the bottom surface of chamber 12′ so that container 14 may be removably connected to the bottom surface of chamber 12′ by rotating container 14 relative to bottle 12.

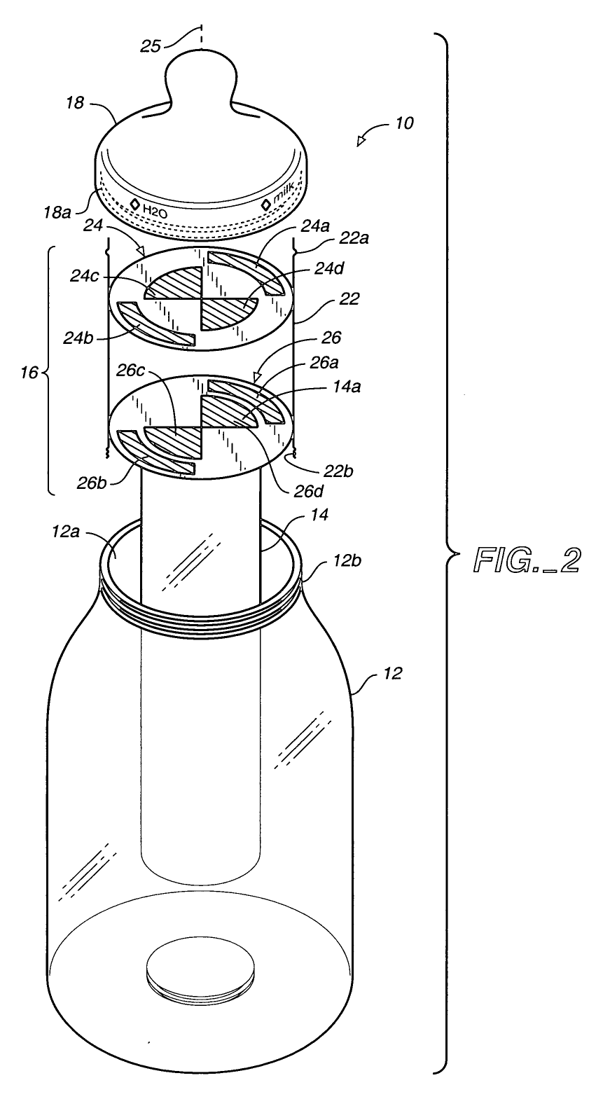

FIG. 2 shows more clearly the construction of the top portion of bottle 12 and container 14 as well as the connection for the valving mechanism 16 to the nipple 18. The top portion of the ring 22 has a protrusion 22a which is complementary with indentation 18a on the inside surface of nipple. This allows a snap-on fit connection between nipple 18 and ring 22. The valving mechanism 16 comprises a ring 22 and two valve members or discs 24 and 26. In FIG. 2, the length of ring 22 has been exaggerated and the valve members 24 and 26 have been tilted in position towards the viewer to show more clearly their construction. As shown in FIG. 2, bottle 12 has an opening 12a and container 14 has an opening 14a. It will be apparent that the openings 12a and 14a are relatively large, so that it is easier to introduce or pour liquid into each of the two containers without spilling and that it is much easier to clean the inside surfaces of the bottle 12 and container 14 compared to other designs. Furthermore, in the embodiment where container 14 is removably connected to bottle 12, bottle 12 can be filled or cleaned after container 14 has been removed, further making it easier to clean the inside surface of the bottle. The desired liquid can also be introduced or poured into container 12 through opening 12a when container 14 is not in the bottle, thereby reducing the chance of spillage.

The liquid contained in bottle 12 and that in container 14 can be selectively connected in fluid communication with nipple 18 by means of the valving mechanism 16. In FIG. 2, the shaded portions of the valve discs 24 and 26 mark holes or apertures in the discs. Thus disc 24 defines a pair of elongated and arc-shaped apertures 24a, 24b therein which serve to pass through liquids from bottle 12 to the nipple 18. Disc 26 defines a similar pair of elongated and arc-shaped holes or apertures 26a, 26b to permit fluid communication between bottle 12 and nipple 18. Disc 14 also defines another pair of holes or apertures 24c and 24d therein which permit fluid or liquid communication between container 14 and nipple 18. Disc 26 defines a similar pair of holes or apertures 26c, 26d for similar purposes.

Thus when discs 24 and 26 are situated right next to each other (by collapsing mechanism 16) with disc 26 contiguous to the openings 14a and 12a of container 14 and bottle 12, it will be observed that aperture 24a will be situated right above aperture 26a and aperture 24b will be situated right above aperture 26b when the two discs 26 and 24 are oriented as shown in FIG. 2. This means that liquid or fluid from bottle 12 may pass through the two pairs of apertures 24a, 26a and 24b, 26b to nipple 18. Where the discs 24 and 26 are situated and oriented as shown in FIG. 2 right next to each other, apertures 24c and 24d will be situated immediately above the solid portions of disc 26 between the two apertures 26c and 26d. This means that the passage from container 14 to nipple 18 is blocked, so that there is fluid communication only between bottle 12 and nipple 18 and not between container 14 and nipple 18.

However, if relative rotation is caused between the two discs 24 and 26 by about 90° (e.g. in a counter-clockwise direction when viewing top down from the nipple towards the discs 24 and 26) , it will be observed that the situation will be reversed from that described above. In such a situation, the pair of apertures 24a, 24b of disc 24 will be situated above solid portions of disc 26 whereas the pair of apertures 24c, 24d will be situated immediately above the pair of apertures 26c and 26d of disc 26. This permits fluid communication from container 14 to nipple 18 but that fluid communication between bottle 12 and nipple 18 will be blocked. Therefore by causing relative rotation between the to discs 24 and 26, it is possible to selectively connect either one of bottle 12 and container 14 to nipple 18.

Discs 24 and 26 are situated inside ring 22, which permits relative rotation between the two discs and keeps the two discs in place and immediately adjacent to each other to avoid leakage. The inside surface of ring 22 defines grooves 22b therein which are complimentary to the grooves 12b on the outside surface of bottle 12 near opening 12a. Therefore ring 22 may be screwed onto the matching grooves 12b of bottle 12, thereby connecting the ring and the bottle in a manner that reduces or prevents leakage. Preferably, disc 26 is attached to ring 22 so that it is fixed in position relative to the ring whereas disc 24 is rotatable relative to the disc 26 and ring 22 about an axis 25 of the device 10 by means of a turning lever 24′ shown in FIG. 1. Thus ring 22 may define a window 22′ therein shown in FIG. 1 which permits rotation of lever 24′. When lever 24′ is rotated to a position that matches the mark (i.e. is directly underneath the mark) on the nipple indicating “H₂O” in FIG. 2, this means that the nipple 18 is now in communication with one of the two reservoirs containing a liquid such as water (e.g. chamber 12′ in bottle 12). When lever 24′ is moved to a position where it matches the position of the marker “milk” on the nipple 18, this means that the remaining reservoir (e.g. reservoir 14′ in container 14) containing a liquid such as milk is now in fluid communication with the nipple 18. The operation of the valving mechanism 16 for selectively connecting bottle 12 or container 14 to the nipple 18 is described above.

To assist parents in gauging how much liquid such as water that should be introduced or poured into bottle 12 for consumption by the child while container 14 is removed and not within chamber 12′, a mark 30 is provided as shown in FIG. 1. Then when container 14 is inserted into chamber 12′ after the liquid has been poured, this would not cause the liquid in bottle 12 to overflow. Mark 30 also allows parents to gauge the amount of water or other liquid that should be contained in bottle 12. Marks 32 may also be provided for container 14 to permit parents to gauge the amount of other liquids such as milk that should be placed in container 14.

By constructing the two reservoirs 12 and 14 in such a manner that the reservoir defined by bottle 12 substantially surrounds that in container 14, and when container 14 is filled with milk and bottle 12 with water, the water inside bottle 12 appears to be a part of the wall of the device 10, giving the illusion that device 10 contains only milk in container 14. This may help a parent in persuading a child to suck liquid from nipple 18 compared to a design where it is more apparent to the child that the device contains separate containers, one for milk and one for water. For this reason, it is advantageous for the outside reservoir to substantially surround the inside reservoir, and to have an external shape that resembles the external shape of the device 10. In the embodiment of FIG. 1, the reservoir or chamber 12′ has an external shape that resembles that of the bottle 12 and of device 10.

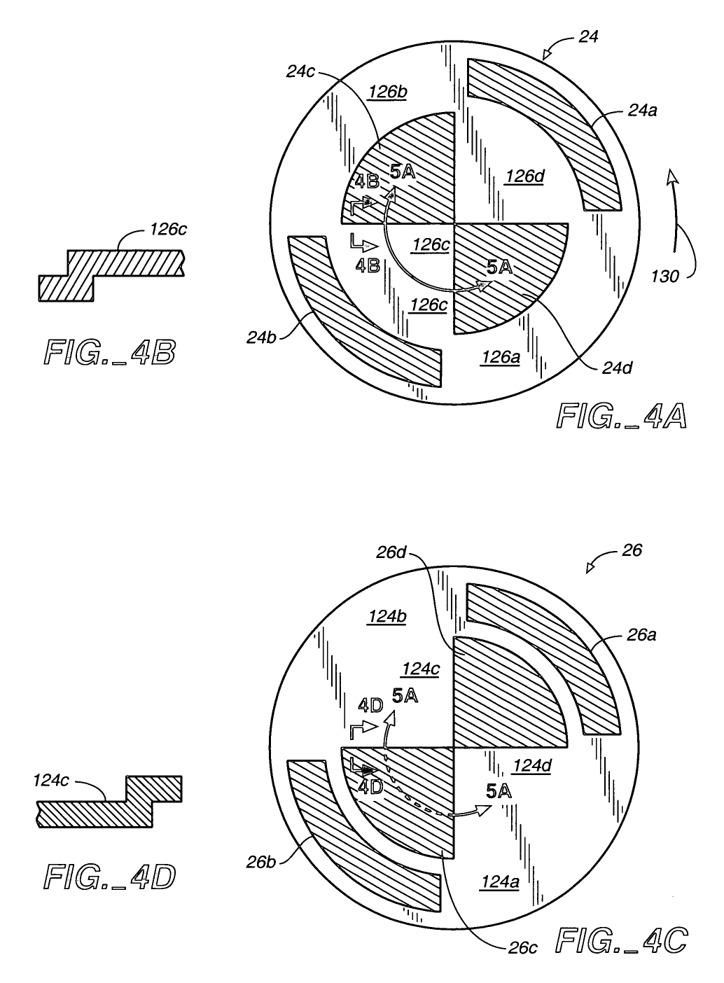

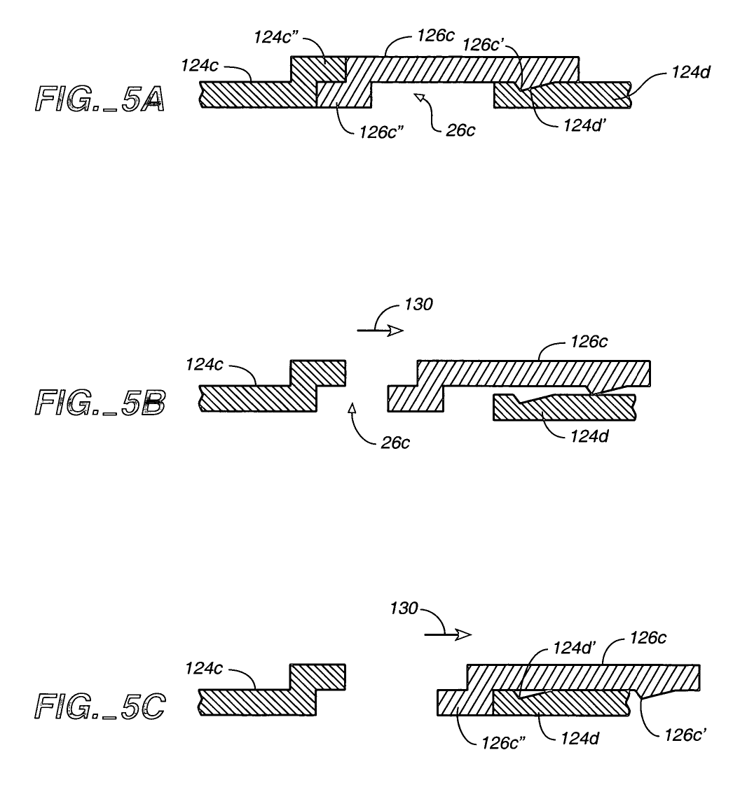

The operation of the valve members or discs in the valve mechanism 16 is illustrated in more detail in FIGS. 4A-4D and 5A-5C. The valve members or discs 24 and 26 are such that if they superimpose with the orientations shown in FIGS. 4A and 4C, the holes or apertures 24a and 26a will overlap and the holes or apertures 24b and 26b will overlap, thereby permitting fluid communication between nipple 18 and the reservoir or chamber 12′ in bottle 12, while blocking fluid passage between container 14 and nipple 18. Thus the aperture 26c in disc 26 in fluid communication with container 14 is blocked by the solid portion 126c of disc 24 and the aperture 26d is blocked by the solid portion 126d of disc 24. FIGS. 4B and 4D are each a cross-sectional view of an edge of a portion of the valve members in respective circles in FIGS. 4A and 4C respectively.

One of the edges of each of the solid portions 124c, 124d, 126c, 126d is beveled as illustrated in FIGS. 4B and 4D. A cross-sectional view of discs 24 and 26 when they are placed adjacent to each other with the orientations shown in FIGS. 4A and 4C is illustrated in FIG. 5A, which is a cross-sectional view of the two discs taken along the circular line 5A-5A in FIGS. 4A and 4C. Thus as more clearly shown in FIG. 5A, when the two discs 24 and 26 are placed contiguous to each other as shown in FIG. 5A, the solid portion 126c of disc 24 fits between the solid portions 124c and 124d of disc 24, thereby covering aperture 26c of-disc 26 and blocking fluid passage between container 14 and nipple 18. As also shown in FIG. 5A, the surfaces of portions 126c and 124d that are in contact with each other are each provided with a mechanism-to reduce leakage. Thus, the portion 126c has a protrusion 126c′ and a surface of portion 124d defines therein a matching indentation 124d′, so that the protrusion 126c′ fits into the indentation 124d′ when portion 126c is in the position shown in FIG. 5A, thereby reducing the leakage between portions 126c and 124d. The matching beveled edges 124c″, 126c″ of portions 124c and 126c when in contact also reduces leakage between such two portions as shown in FIG. 5A. As illustrated in FIG. 5A, the dimension of portion 126c along the circumferential direction exceeds that of the aperture 26c so that there is no leakage through aperture 26c. In a similar manner, portion 126d entirely covers the aperture 26d and has a shape and is connected to portions 124c and 124d in a manner similar to portion 126c illustrated in FIG. 5A.

In the example above, bottle 12 contains water and container 14 milk. Thus the above described configuration and orientation of discs 24 and 26 would permit the child to suck in water from bottle 12 rather than milk. To provide milk rather than water, the parent would rotate disc 24 relative to disc 26 in a counterclockwise direction along arrow 130 in FIG. 4A. Disc 26 is preferably substantially fixed in position relative to ring 22, such as by being attached to ring 22. This configuration is illustrated in FIG. 5B. Thus as illustrated in FIG. 5B, portion 126c is moved away from portion 124c and toward portion 124d. This then uncovers a portion of aperture 26c. To completely open up aperture 26c and to block the fluid passage between bottle 12 and nipple 18, disc 24 is rotated along arrow 130 until the beveled portion 126c″ is in contact with the edge of portion 124d as shown in FIG. 5C. When the two discs 24, 26 are in this relative position as shown in FIG. 5C, portion 126b of disc 24 will have moved to overlap and cover aperture 26b of disc 26 and portion 126a of disc 24 will have moved to overlap aperture 26a of disc 26, thereby closing off the apertures 26a and 26b and blocking passage of fluids between bottle 12 and nipple 18. Thus when disc 24 and 26 are in the relative position as illustrated in FIG. 5C, fluid communication between container 14 and the nipple is opened and the fluid communication between bottle 12 and nipple 18 is blocked.

With the apertures of disc 24 and 26 as shown in FIGS. 4A and 4C, a rotation of about 90° along arrow 130 will cause the fluid passage to bottle 12 to be blocked and the fluid passage from container 14 to nipple 18 to be opened. To reverse the process, disc 24 may be rotated in a counterclockwise direction (i.e. in the direction opposite to arrow 130) from the position shown in FIG. SC (through the position shown in FIG. 5B) until the beveled portions 124c″ and 126c″ are again in contact as shown in FIG. 5A, thereby shutting off milk supplied by container 14 and permitting water from bottle 12 to be again supplied to nipple 18.

From the above, it will be observed that by a relatively small angle of rotation (e.g. about 90°), a parent can readily select the liquid in either container 14 or that in bottle 12 to be provided to the child through nipple 18. This permits the parent to perform the above rotation operation using only one hand, thereby freeing the other hand for other purposes, such as holding an infant. While preferably a rotation of 90° between discs 24 and 26 will permit the selection of one liquid or the other, the apertures in discs 24 and 26 may be designed to be different from those shown in FIGS. 4A and 4C so that a rotation of a different angle than 90° will effectively achieve the above-described selection, such as a relative rotation of an angle of less than 180° and preferably not more than 150°. In any event, one is not required to rotate one disc relative to the other by 180° to achieve the selection as in the nursing bottle proposed by Wagner. Hence, a parent may perform the above rotation and selection of the liquid to be provided to the child without removing the nipple from the child's mouth.

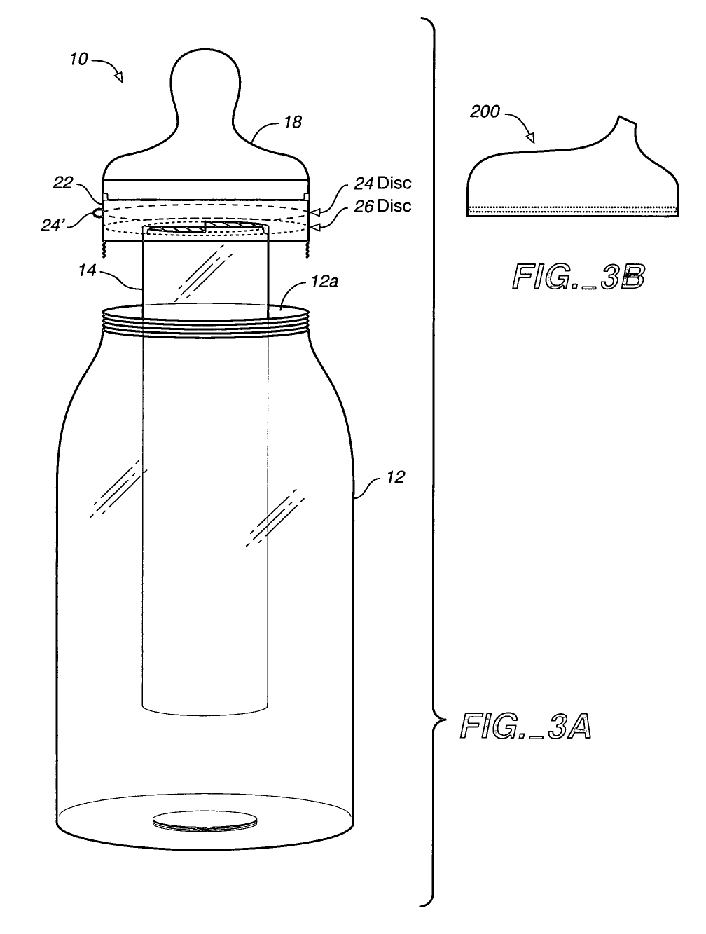

FIG. 3B is a schematic view of a zipping cap which may be used in lieu of the nipple 18 shown in FIG. 3A. Preferably, zipping cap 200 is provided with a snap-on mechanism similar to that of nipple 18 so that it can be readily connected to ring 24 in the same manner as nipple 18. In this manner, when the child outgrows intake of fluids through nipple 18, nipple 18 may be replaced by the zipping cap 200 so that the child can drink from device 10 instead of through nipple 18. This provides a smooth transition for the child from sucking a nipple to drinking from a cup.

Thus, the above described device 10 comprising a bottle including a first and a second reservoir for carrying different liquids, a conduit (e.g. nipple or zipping cap) for providing a liquid into a child's mouth and a valve interconnecting the reservoirs with the conduit may be operated as follows. One introduces a first liquid into the first reservoir until a predetermined volume of liquid is contained in the first reservoir. Then relative motion is caused between the first and second reservoirs until the second reservoir is substantially surrounded by the first reservoir. This may be accomplished by inserting the second reservoir into the first reservoir. Prior to the insertion, one may wish to first introduce another liquid (preferably different from the first liquid) into the second reservoir. After liquid has been delivered liquid from one of the reservoirs into the conduit and into the child's mouth for some time, the valve is manipulated so that liquid is dispensed from the other reservoir instead without removing the conduit from a child's mouth.

Preferably the valve comprises a first and a second valve member, each valve member having a first opening for communication with the first reservoir, and a second opening for communication with the second reservoir, and said manipulating comprises rotating one valve member relative to the other valve member by not more than 150 degrees, or an angle that is achievable by means of one hand.

For cleaning the reservoirs, the second reservoir is first removed from the first reservoir such as by withdrawing it from inside the first reservoir, and the reservoirs are cleaned after the second reservoir is removed from the first reservoir.

In the embodiment described above, container 14 is placed within bottle 12, forming a Baby Bottle in a bottle configuration. Baby bottles are not only important in its shape, size and handling but also in its convenience and function. The Baby Bottle in a bottle is different from other bottles and multi-reservoir bottle in that it serves many purposes. It reduces and prevents Baby bottle tooth decay. It is adaptable and grows with the child from infant state to toddler. By having a centric/inner bottle for milk or sugar containing liquid and a surrounding outer bottle for water, it gives an illusion that the bottle only contains milk or sugar containing liquid. Parents will experience the convenience of one bottle holding two type of liquids. They will have the comfort and peace of mind that their baby would not be part of the statistics of having multiple decays before age of one. This bottle would allow the parents to associate their kids to drink water after every meal. It is hard enough for parents to get their babies to initially want a bottle. Constantly, switching to different bottles as they grow would be even harder. When the baby reaches toddler, they would be able to use the adaptable zipping top and turn to the different compartments themselves.

This embodiment of baby bottle design has 2 in 1 concept. A bottle in a bottle with one nursing/drinking top that will allow the child to drink fluid such as milk or sugar containing liquid from the centric/inner bottle then with an easy turn of the container cap the liquid such as water surrounding the centric bottle can be expelled to wash the mouth of the sugar content.

This embodiment has a single nipple cap that can also be exchanged with a toddler zipping cap when the infant grows older. The centric straight container or bottle 14 carries the sugar liquid/milk up to 6-8 ounces. It is a complete container in itself. It preferably has the same height as the outer container 12. It is preferably attached to the floor of the outer bottle by twist on or snap on. This is surrounded by the outer bottle which carries the water. This way after each meal, it is convenient and easy for the care taker to separate the bottles for proper and thorough cleaning without running the risk of residue trapped in the bottom or the sides of the bottles.

There are numerous benefits of having this type of baby bottle. First, it can help prevent early baby bottle tooth decay. Baby bottle tooth decay is one of the leading epidemics in children's oral diseases today. Many children as early as one can develop tooth decay due to lack of oral hygiene and bad oral habits. Rinsing the child's mouth with water after each meal is essential in maintaining good oral health. This is an important habit to start even before the first tooth appears. Water help wash away the sugar content of the meal; therefore, it will help reduce the number of cavities in the mouth.

The second benefit of this bottle is in the convenience. New parents are usually too busy and tired to always rinse baby's mouth after every meal. Parents who are professionals relying on others for the care of their baby may have difficulty monitoring if the grandparents, nanny, or uncles or aunties actually remembers to go the extra mile to get the water after their baby has his formula or milk. It eliminates the need to bring a second water bottle. By having this convenient baby bottle, one will never forget to always have the baby drink some water after milk to wash his mouth. Care takers have the convenience to switch to water without the baby realizing what they are drinking. By the time they find out they would have drank enough water to clean their mouth of sugar content. Also, this is a good and convenient way for the parent to gage how much water the infant or toddler has drank after a sugar meal before giving sugar content. This is also a great way to wean the baby off the bottle doing nap/sleep. If the baby knew that the bottle that looked like milk tasted like water they would not want it before bed time. Even if they insist on getting the milk during nap/sleep the parent can easily switch to water after a few suckles.

Finally, this baby bottle will help a child learn and develop good oral habits. It allows the baby early on to associate drinking water after every meal. As the child becomes a toddler and have better motor skills, he/she can use the familiar bottle with the interchangeable zipping cap and turn it themselves for water after their juices and milk.

While the invention has been described above by reference to various embodiments, it will be understood that changes and modifications may be made without departing from the scope of the invention, which is to be defined only by the appended claims and their equivalents. Thus, while in the preferred embodiments, container 14 is placed inside bottle 12, this is not required and the two reservoirs may be constructed so that one reservoir surrounds the other without the inside reservoir being placed inside the surrounding reservoir. Thus bottle 12 may be replaced by another container which is shaped like a donut with a hole there through which container 14 may be inserted. Such and other variations are within the scope of the invention.

We claim:

1. A nursing apparatus comprising:
a bottle including a plurality of reservoirs for carrying different liquids, wherein at least one of the reservoirs is substantially surrounded by another one of the reservoirs;
a conduit for providing a liquid into a child's mouth; and
a valve interconnecting the reservoirs with the conduit, the valve selectively coupling the conduit in fluid communication with each of the reservoirs so that liquid carried in one of the reservoirs can be substituted for liquid carried in another one of the reservoirs without removing the conduit from a child's mouth.

2. The apparatus of claim 1, wherein said bottle includes a first and a second reservoir, the first reservoir surrounding the second reservoir.

3. The apparatus of claim 2, said first reservoir having an external shape resembling an external shape of the bottle.

4. The apparatus of claim 2, wherein said valve comprises a first and a second valve member, each valve member having a first opening for communication with the first reservoir, and a second opening for communication with the second reservoir.

5. The apparatus of claim 2, wherein said first and second valve members are movable relative to each other, so that when they are in first relative positions, their first openings are at least partly aligned to permit passage of liquid from the first reservoir to the conduit while not permitting passage of liquid from the second reservoir to the conduit, and when they are in second relative positions, their second openings are at least partly aligned to permit passage of liquid from the second reservoir to the conduit while not permitting passage of liquid from the first reservoir to the conduit.

6. The apparatus of claim 5, wherein the two valve members are movable between the two relative positions by rotating one valve member relative to the other valve member.

7. The apparatus of claim 5, wherein the two valve members are movable between the two relative positions by rotating one valve member relative to the other valve member by not more than about 150 degrees.

8. The apparatus of claim 5, wherein the two valve members are movable between the two relative positions by rotating one valve member relative to the other valve member by less than about 180 degrees.

9. The apparatus of claim 2, wherein said first reservoir comprises a marker for marking a predetermined volume of liquid that will be contained in the first reservoir when the second reservoir is surrounded by the first reservoir.

10. The apparatus of claim 1, wherein said valve comprises a first and a second valve member, each valve member having a first opening for communication with the first reservoir, and a second opening for communication with the second reservoir, and wherein liquid carried in one of the reservoirs can be substituted for liquid carried in another one of the reservoirs by rotating one of the valve members relative to the other valve member by not more than about 150 degrees.

11. The apparatus of claim 1, wherein said conduit comprises a nipple or zipping cap.

12. The apparatus of claim 1, wherein said conduit comprises a nipple and a zipping cap, wherein said bottle is configured to be connected to the nipple and zipping cap in fluid tight connection.

13. The apparatus of claim 1, wherein said bottle defines a chamber therein forming a first one of the reservoirs, said bottle including a container in chamber, said container defining therein a second reservoir.

14. The apparatus of claim 13, wherein said container is removably connected to the bottle.

15. A method for using a nursing apparatus, said apparatus comprising:
a bottle including a first and a second reservoir for carrying different liquids;
a conduit for providing a liquid into a child's mouth; and
a valve interconnecting the reservoirs with the conduit, said method comprising:
introducing a liquid into the first reservoir until a predetermined volume of liquid is contained in the first reservoir; and
causing relative motion between the first and second reservoirs until the second reservoir is substantially surrounded by the first reservoir.

16. The method of claim 15, further comprising introducing another liquid into the second reservoir.

17. The method of claim 16, said method further comprising:
delivering liquid from one of the reservoirs into the conduit; and
manipulating the valve so that liquid is dispensed from the other reservoir instead without removing the conduit from a child's mouth.

18. The method of claim 17, wherein said valve comprises a first and a second valve member, each valve member having a first opening for communication with the first reservoir, and a second opening for communication with the second reservoir, wherein said manipulating comprises rotating one valve member relative to the other valve member by not more than 150 degrees.

19. The method of claim 17, wherein said valve comprises a first and a second valve member, each valve member having a first opening for communication with the first reservoir, and a second opening for communication with the second reservoir, wherein said manipulating comprises rotating one valve member relative to the other valve member by an angle that is achievable by means of one hand.

20. The method of claim 17, further comprising removing said second reservoir from the first reservoir.

21. The method of claim 20, further comprising cleaning the reservoirs after the second reservoir is removed from the first reservoir.

22. The method of claim 20, wherein said causing causes the second reservoir to be inserted into the first reservoir.

23. The method of claim 22, further comprising withdrawing said second reservoir from within the first reservoir.

24. The method of claim 15, wherein said first reservoir comprises a marker for marking a predetermined volume of liquid that will be contained in the first reservoir when the second reservoir is surrounded by the first reservoir, and said introducing introduces a liquid into the first reservoir until said marker is reached.

25. The method of claim 15, said conduit comprising a nipple or a nipple, said apparatus further comprising a zipping cap or a nipple, wherein the method further comprises replacing the nipple with the zipping cap or the zipping cap with the nipple for providing liquid from the reservoirs to the child's mouth.

26. The method of claim 15, wherein said causing causes the second reservoir to be inserted into the first reservoir.
